(19) United States
(12) Patent Application Publication
(10) Pub. No.: US 2025/0071793 A1
(43) Pub. Date: Feb. 27, 2025

(54) INFORMATION TRANSMISSION METHOD, NODE, MEDIUM, AND PROGRAM PRODUCT

(71) Applicant: GUANGDONG OPPO MOBILE TELECOMMUNICATIONS CORP., LTD., Dongguan (CN)

(72) Inventors: Yanan LIN, Dongguan (CN); Jing XU, Dongguan (CN)

(21) Appl. No.: 18/944,093

(22) Filed: Nov. 12, 2024

Related U.S. Application Data
(63) Continuation of application No. PCT/CN2022/092846, filed on May 13, 2022.

(51) Int. Cl. H04W 72/542; H04W 24/10; H04W 84/18

(52) U.S. Cl. CPC H04W 72/542; H04W 24/10; H04W 84/18

(57) ABSTRACT

An information transmission method, including: receiving configuration information, where the configuration information is used to indicate N sets of transmission resources, and N is a positive integer; receiving a signal from at least one sensing node through the N sets of transmission resources; determining N pieces of reporting information based on the signal from the at least one sensing node; and transmitting the N pieces of reporting information to a control node.

### CROSS-REFERENCE TO RELATED APPLICATION

This application is a Continuation Application of International Application No. PCT/CN2022/092846 filed on May 13, 2022, which is incorporated herein by reference in its entirety.

### TECHNICAL FIELD

The present disclosure belongs to the field of sensing communication technology, and specifically relates to an information transmission method, a node, a medium, and a program product.

### BACKGROUND

In a communication system, wireless sensing may be used to detect parameters of physical environment, thereby achieving target positioning, action recognition, imaging, or the like.

Traditional wireless sensing and wireless communication exist independently, and there is a waste of wireless spectrum and hardware resources in separated design. In future, after entering the Beyond 5G (beyond a fifth generation mobile communication system, B5G) era and the 6G era, it is possible to utilize base stations and multiple terminals for joint sensing. In a wireless communication system, when there are multiple sensing nodes (such as, a base station, a mobile phone or an IoT device that can transmit a signal) around a sensed node, accuracy of sensing may be improved by joint participation of multiple sensing nodes.

However, although more number of nodes participating in sensing is beneficial to improving sensing performance, in terms of efficiency, efficiency is not necessarily highest with more nodes. Therefore, how to select an appropriate sensing node from the multiple sensing nodes to participate in sensing is an urgent problem that needs to be solved.

### SUMMARY

The embodiments of the present disclosure provide an information transmission method, a node, a medium and a program product.

In order to solve the above technical problem, the present disclosure is implemented as follows.

In a first aspect, the embodiments of the present disclosure provide an information transmission method, which is applied to a sensed node. The method includes: receiving configuration information, where the configuration information is used to indicate N sets of transmission resources, and N is a positive integer; receiving a signal from at least one sensing node through N sets of transmission resources; determining N pieces of reporting information based on a signal from the at least one sensing node; and transmitting the N pieces of reporting information to a control node.

In a second aspect, the embodiments of the present disclosure provide an information transmission method, which is applied to a control node. The method includes: transmitting configuration information, where the configuration information is used to indicate N sets of transmission resources, the N sets of transmission resources are used for at least one sensing node to transmit a signal to a sensed node, and N is a positive integer; and receiving N pieces of reporting information from the sensed node, where the N pieces of reporting information are determined by the sensed node based on a signal transmitted by the at least one sensing node on the N sets of transmission resources.

In a third aspect, the embodiments of the present disclosure provide an information transmission method, which is applied to a control node. The method includes: transmitting configuration information, where the configuration information is used to indicate a first transmission resource used for a first sensing node to transmit a signal to a sensed node; and receiving N pieces of reporting information from the sensed node, where the N pieces of reporting information are determined by the sensed node based on a signal transmitted by at least one sensing node through N sets of transmission resources, the N sets of transmission resources include a first transmission resource, the at least one sensing node includes a first sensing node, and N is a positive integer.

In a fourth aspect, the embodiments of the present disclosure provide an information transmission method, which is applied to a first sensing node. The method includes: receiving configuration information, where the configuration information is used to indicate a first transmission resource used for a first sensing node to transmit a signal to a sensed node, the first transmission resource is a transmission resource of N sets of transmission resources, the N sets of transmission resources are used for at least one sensing node to transmit a signal to the sensed node, the at least one sensing node includes the first sensing node, and N is a positive integer; and transmitting the signal to the sensed node on the first transmission resource.

In a fifth aspect, the embodiments of the present disclosure provide a sensed node, the sensed node includes: a receiving module, a determining module and a transmitting module. The receiving module is configured to receive configuration information, where the configuration information is used to indicate N sets of transmission resources, and N is a positive integer; the receiving module is further configured to receive a signal from at least one sensing node through the N sets of transmission resources; the determining module is configured to determine N pieces of reporting information based on the signal from the at least one sensing node; and the transmitting module is configured to transmit the N pieces of reporting information to a control node.

In a sixth aspect, the embodiments of the present disclosure provide a control node, where the control node includes: a transmitting module and a receiving module. The transmitting module is configured to transmit configuration information, where the configuration information is used to indicate N sets of transmission resources, the N sets of transmission resources are used for at least one sensing node to transmit a signal to a sensed node, and N is a positive integer; and the receiving module is configured to receive N pieces of reporting information from the sensed node, where the N pieces of reporting information are determined by the sensed node based on the signal transmitted by the at least one sensing node on the N sets of transmission resources.

In a seventh aspect, the embodiments of the present disclosure provide a control node, where the control node includes: a transmitting module and a receiving module. The transmitting module is configured to transmit configuration information, where the configuration information is used to indicate a first transmission resource used for a first sensing node to transmit a signal to a sensed node; and the receiving module is configured to receive N pieces of reporting information from the sensed node, where the N pieces of reporting information are determined by the sensed node based on a signal transmitted by at least one sensing node through N sets of transmission resources, the N sets of transmission resources include a first transmission resource, the at least one sensing node includes a first sensing node, and N is a positive integer.

In an eighth aspect, the embodiments of the present disclosure provide a sensing node, the sensing node is a first sensing node, and the first sensing node includes: a receiving module and a transmitting module. The receiving module is configured to receive configuration information, where the configuration information is used to indicate a first transmission resource used for a first sensing node to transmit a signal to a sensed node, the first transmission resource is a transmission resource of N sets of transmission resources, the N sets of transmission resources are used for at least one sensing node to transmit a signal to the sensed node, the at least one sensing node includes the first sensing node, and N is a positive integer; and the transmitting module is configured to transmit the signal to the sensed node on the first transmission resource. In a ninth aspect, the embodiments of the present disclosure provide a sensed node, the sensed node includes a processor, a memory, and a program or instructions stored in the memory and runnable on the processor, where the processor, when executing the program or the instructions, is configured to implement steps of the information transmission method according to the first aspect.

In a tenth aspect, the embodiments of the present disclosure provide a control node, the control node includes a processor, a memory, and a program or instructions stored in the memory and runnable on the processor, where the processor, when executing the program or the instructions, is configured to implement steps of the information transmission method according to the second aspect or the third aspect.

In an eleventh aspect, the embodiments of the present disclosure provide a sensing node, the sensing node includes a processor, a memory, and a program or instructions stored in the memory and runnable on the processor, where the processor, when executing the program or the instructions, is configured to implement steps of the information transmission method according to the fourth aspect.

In a twelfth aspect, the embodiments of the present disclosure provide a readable storage medium, where the readable storage medium is configured to store a program or instructions, and the program or the instructions, when being executed by a processor, implement steps of the information transmission method according to the first aspect, the second aspect, the third aspect or the fourth aspect.

In a thirteenth aspect, the embodiments of the present disclosure provide a chip, the chip includes a processor and a communication interface, where the communication interface is coupled to the processor, and the processor is configured to run a program or instructions to implement the information transmission method according to the first aspect, the second aspect, the third aspect or the fourth aspect.

In a fourteenth aspect, the embodiments of the present disclosure provide a computer program product including instructions, when the instructions are executed on a computer, causes a computer to perform steps of the information transmission method according to the first aspect, the second aspect, the third aspect or the fourth aspect.

### BRIEF DESCRIPTION OF THE DRAWINGS

FIG. 1 is an architecture schematic diagram of a sensing system provided by the embodiments of the present disclosure.

FIG. 2 is a first schematic diagram of an interaction flow of the information transmission method provided by the embodiments of the present disclosure.

FIG. 3A to 3B are time domain schematic diagrams of a transmission resource provided by the embodiments of the present disclosure.

FIG. 4 is a schematic diagram of a periodicity of a transmission resource provided by the embodiments of the present disclosure.

FIG. 5A to 5C are schematic diagrams of time domain continuity of a transmission resource provided by the embodiments of the present disclosure.

FIG. 6A to 6C are first schematic diagrams of one set of transmission resources including at least two transmission opportunities provided by the embodiments of the present disclosure.

FIG. 7A to 7B are second schematic diagrams of one set of transmission resources including at least two transmission opportunities provided by the embodiments of the present disclosure.

FIGS. 8A to 8C are third schematic diagrams of one set of transmission resources including at least two transmission opportunities provided by the embodiments of the present disclosure.

FIG. 9 is a second schematic diagram of an interaction flow of the information transmission method provided by the embodiments of the present disclosure.

FIG. 10 is a schematic diagram of a possible structure of a sensed node provided by the embodiments of the present disclosure.

FIG. 11 is a schematic diagram of a possible structure of a control node provided by the embodiments of the present disclosure.

FIG. 12 is a schematic diagram of a possible structure of a sensing node provided by the embodiments of the present disclosure.

FIG. 13 is a schematic diagram of a possible structure of a node provided by the embodiments of the present disclosure.

FIG. 14 is a hardware schematic diagram of a node provided by the embodiments of the present disclosure.

### DETAILED DESCRIPTION

For ease of understanding, relevant terms involved in the embodiments of the present disclosure are explained firstly.

### I. Wireless Sensing

Wireless communication and wireless sensing are two major applications of modern radio frequency technology. Herein, wireless sensing can use backscattered radio waves to detect a parameter of physical environment to achieve environmental sensing, such as target positioning, motion recognition, and imaging.

Traditional wireless sensing and communication exist independently, and separated design has a problem of wasting wireless spectrum and a hardware resource. After entering the B5G and 6G era, the communication spectrum can move towards millimeter wave, terahertz, and visible light communication. The spectrum of future wireless communication will overlap with the traditional sensing spectrum.

Future communication sensing technology may integrate the two functions of communication and sensing. The wireless resource management of communication may be used to solve the interference problem in traditional wireless sensing; widely deployed cellular network may be used to realize a larger range of sensing services; a base station and multiple terminals may be used for joint sensing to achieve higher sensing accuracy; and hardware modules of communication may be reused to realize sensing functions and further, reduce costs. In short, communication sensing technology enables a future wireless communication system to have sensing capabilities, thereby providing a kind of foundation for the future development of smart transportation, smart cities, smart factories, drones, and other services.

As mentioned above, there are a large number of terminal devices (such as mobile phones and Internet of Things (IoT) devices) in the wireless communication system. When there are multiple sensing nodes around a sensed node, the joint participation of multiple sensing nodes in sensing will be able to improve the accuracy of sensing, meet more complex sensing service requirements, and provide richer sensing services. It can be understood that when there are multiple sensing nodes in a system, the efficiency can be improved by controlling and managing the entire sensing service through a sensing control node. The control node may be a base station or a mobile terminal. The increase in the number of nodes participating in sensing is beneficial to improving sensing performance, but it is not optimal in terms of efficiency. How to select an appropriate node from multiple sensing nodes to participate in sensing will be a major problem that needs to be studied in communication sensing. For example, if three sensing terminals are included around the sensed terminal, and the three sensing terminals are closer to the sensed terminal than the base station, sensing using the three sensing terminals may be more efficient and accurate than sensing using the base station. Furthermore, in the future, part of multiple sensing terminals may be selected to perform a sensing service according to the performance requirements of the sensing service, characteristics of the sensing terminal, and characteristics of the sensed terminal.

The technical solutions in the embodiments of the present disclosure will be clearly and completely described below in conjunction with the drawings in the embodiments of the present disclosure and apparently, the described embodiments are a part of the embodiments of the present disclosure, but not all of the embodiments. Based on the embodiments of the present disclosure, all other embodiments obtained by the ordinary skilled in the art belong to the protection scope of the present disclosure.

The terms “first”, “second” and the like in the specification and claims of the present disclosure are used to distinguish similar objects but not to describe a particular sequence or order. It should be understood that the data used in this way may be interchangeable under appropriate conditions, so that the embodiments of the present disclosure may be implemented in an order other than that illustrated or described herein, and objects distinguished by “first”, “second”, etc. are generally of the same category, and the number of objects is not limited. For example, the first object may be one or more. In addition, “and/or” in the specification and claims represents at least one of the connected objects, and a character “/” herein generally means that related objects before and after “/” are in an “or” relationship.

It is worth noting that the technology described in the embodiments of the present disclosure is not limited to Long Term Evolution (LTE)/LTE-Advanced (LTE-A) systems, but can also be used in other wireless communication systems, such as Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA) and other systems. The terms “system” and “network” in the embodiments of the present disclosure are often used interchangeably, and the described technology can be used for the systems and radio technologies mentioned above as well as other systems and radio technologies. However, the following description describes an NR system for an exemplary purpose, and an NR terminology is used in most of the following description, although these techniques may also be applicable to applications other than NR system applications, such as 6th Generation (6G) communication systems.

The information transmission method provided by the embodiments of the present disclosure is described in detail below through specific embodiments and application scenarios thereof in conjunction with the drawings.

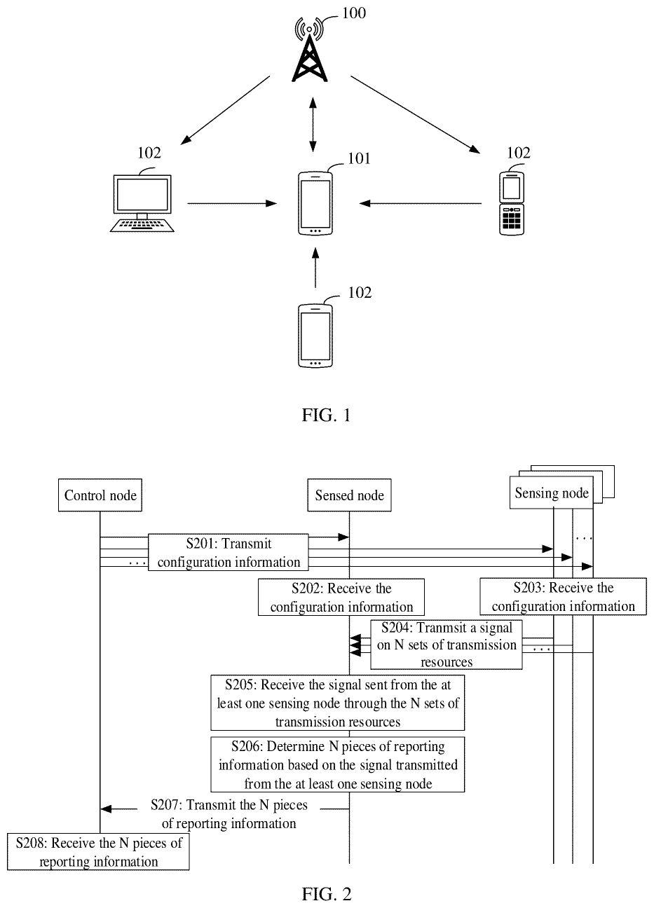

FIG. 1 is an architecture schematic diagram of a sensing system provided by the embodiments of the present disclosure. As shown in FIG. 1, the sensing system includes: a control node 100, a sensed node 101, and at least one sensing node 102. Herein, a control node 100 is configured to transmit configuration information to a sensing node 102 and a sensed node 101 to configure a transmission resource for transmitting a signal, so that each sensing node 102 transmits a signal to the sensed node 101 on the configured transmission resource, and the sensed node 101 receives the signal transmitted from each sensing node 102 on the configured transmission resource, so that the sensed node 101 reports information to the control node 100 according to the received signal, so that the control node 100 may select a sensing node participating in sensing for the sensed node 101 based on the reporting information.

Herein, the control node is a node that controls and manages sensing service, i.e., the control node may control or manage the sensing node to transmit a sensing signal to the sensed node. When the sensing node is configured to perform or participate in sensing, the sensing node may transmit a sensing signal for sensing a sensed node.

In some embodiments of the present disclosure, the control node may be a base station accessed by the sensing node, or may be a sensing node of surrounding sensing nodes.

The embodiments of the present disclosure provide an information transmission method, and the method is applied to a sensed node and includes:
receiving configuration information, where the configuration information is used to indicate N sets of transmission resources, N being a positive integer;
receiving a signal from at least one sensing node through the N sets of transmission resources;
determining N pieces of reporting information based on the signal from the at least one sensing node; and
transmitting the N pieces of reporting information to a control node.

In some embodiments, there is a one-to-one correspondence between the N pieces of reporting information and the N sets of transmission resources.

In some embodiments, each piece of reporting information of the N pieces of reporting information includes at least one of:
passing result information, where the passing result information is used to indicate that a sensing result or a measurement result of a signal received on a set of transmission resources of the N sets of transmission resources satisfies a preset condition;
non-passing result information, where the non-passing result information is used to indicate that a sensing result or a measurement result of a signal received on a set of transmission resources of the N sets of transmission resources does not satisfy a preset condition;
permission information, where the permission information is used to indicate that a sensing node is allowed to transmit a sensing signal or a measurement signal to the sensed node, or indicate that a sensing node that transmits a signal on a set of transmission resources of the N sets of transmission resources is allowed to transmit a sensing signal or a measurement signal to the sensed node;
rejection information, where the rejection information is used to indicate that a sensing node is rejected from transmitting a sensing signal or a measurement signal to the sensed node, or indicate that a sensing node that transmits a signal on a set of transmission resources of the N sets of transmission resources is rejected from transmitting a sensing signal or a measurement signal to the sensed node;
signal amplitude information;
power information;
energy information;
signal phase information;
signal arrival time information; or signal arrival angle information.

In some embodiments, the configuration information further includes characteristic information of one sensing node of the at least one sensing node.

In some embodiments, the one sensing node corresponds to a set of transmission resources of the N sets of transmission resources.

In some embodiments, the characteristic information includes at least one of:
a device type, a device capability, power supply information, device location information, or device antenna configuration information.

In some embodiments, where transmitting the N pieces of reporting information to the control node includes:
transmitting the N pieces of reporting information to the control node through one physical channel; or
transmitting the N pieces of reporting information to the control node through M physical channels, where M is a positive integer less than or equal to N.

In some embodiments, where transmitting the N pieces of reporting information to the control node through the one physical channel includes:
jointly encoding the N pieces of reporting information and transmitting the N pieces of reporting information to the control node through the one physical channel.

In some embodiments, there is a one-to-one relationship between the N sets of transmission resources and the at least one sensing node; or
there is a one-to-many relationship between the N sets of transmission resources and the at least one sensing node; or
there is a many-to-one relationship between the N sets of transmission resources and the at least one sensing node.

In some embodiments, each set of transmission resources of the N sets of transmission resources is independently configured.

In some embodiments, each set of transmission resources of the N sets of transmission resources includes a transmission opportunity; and the N sets of transmission resources satisfy any one of:
the N sets of transmission resources being periodic transmission resources; or
the N sets of transmission resources being transmission resources that are continuous in time domain.

In some embodiments, at least one set of transmission resources of the N sets of transmission resources includes at least two transmission opportunities; and the at least two transmission opportunities satisfy any one of:
the at least two transmission opportunities being periodic transmission opportunities;
the at least two transmission opportunities being transmission opportunities that are continuous in time domain; or
the at least two transmission opportunities being transmission opportunities that are discretely distributed in time domain.

The embodiments of the present disclosure provide an information transmission method, and the method is applied to a control node and includes:
transmitting configuration information, where the configuration information is used to indicate N sets of transmission resources, and the N sets of transmission resources are used for at least one sensing node to transmit a signal to a sensed node, N being a positive integer; and
receiving N pieces of reporting information from the sensed node, where the N pieces of reporting information are determined by the sensed node based on a signal transmitted by the at least one sensing node on the N sets of transmission resources.

In some embodiments, there is a one-to-one correspondence between the N pieces of reporting information and the N sets of transmission resources.

In some embodiments, each set of transmission resources of the N sets of transmission resources is independently configured.

In some embodiments, each set of transmission resources of the N sets of transmission resources includes a transmission opportunity; and the N sets of transmission resources satisfy any one of:
the N sets of transmission resources being periodic transmission resources; or
the N sets of transmission resources being transmission resources that are continuous in time domain.

In some embodiments, the N sets of transmission resources are periodic transmission resources; and the configuration information further includes at least one of:
a first time unit, where the first time unit is a time unit where a first set of transmission resources of the N sets of transmission resources is located; or
a time offset.

In some embodiments, the N sets of transmission resources are periodic transmission resources; and after transmitting the configuration information, the method further includes:
transmitting first information;
where the first information includes at least one of a first time unit or a time offset, and the first time unit is a time unit where a first set of transmission resources of the N sets of transmission resources is located.

In some embodiments, at least one set of transmission resources of the N sets of transmission resources includes at least two transmission opportunities; and the at least two transmission opportunities satisfy any one of:
the at least two transmission opportunities being periodic transmission opportunities;
the at least two transmission opportunities being transmission opportunities that are continuous in time domain; or
the at least two transmission opportunities being transmission opportunities that are discretely distributed in time domain.

In some embodiments, there is a one-to-one relationship between the N sets of transmission resources and the at least one sensing node; or
there is a one-to-many relationship between the N sets of transmission resources and the at least one sensing node; or
there is a many-to-one relationship between the N sets of transmission resources and the at least one sensing node.

In some embodiments, the configuration information further includes characteristic information of a first sensing node of the at least one sensing node.

In some embodiments, the first sensing node corresponds to a set of transmission resources of the N sets of transmission resources.

In some embodiments, the characteristic information includes at least one of:
a device type, a device capability, power supply information, device location information, or device antenna configuration information.

In some embodiments, the reporting information includes at least one of:
passing result information, where the passing result information is used to indicate that a sensing result or a measurement result of a signal received on a set of transmission resources of the N sets of transmission resources satisfies a preset condition;
non-passing result information, where the non-passing result information is used to indicate that a sensing result or a measurement result of a signal received on a set of transmission resources of the N sets of transmission resources does not satisfy a preset condition;
permission information, where the permission information is used to indicate that a sensing node is allowed to transmit a sensing signal or a measurement signal to the sensed node, or indicate that a sensing node that transmits a signal on a set of transmission resources of the N sets of transmission resources is allowed to transmit a sensing signal or a measurement signal to the sensed node;
rejection information, where the rejection information is used to indicate that a sensing node is rejected from transmitting a sensing signal or a measurement signal to the sensed node, or indicate that a sensing node that transmits a signal on a set of transmission resources of the N sets of transmission resources is rejected from transmitting a sensing signal or a measurement signal to the sensed node;
signal amplitude information;
power information;
energy information;
signal phase information;
signal time of arrival information; or signal angle of arrival information.

In some embodiments, where receiving the N pieces of reporting information from the sensed node includes:
receiving the N pieces of reporting information from the sensed node through one physical channel; or
receiving the N pieces of reporting information from the sensed node through M physical channels, where M is a positive integer less than or equal to N.

The embodiments of the present disclosure provide an information transmission method, and the method is applied to a control node and includes:
transmitting configuration information, where the configuration information is used to indicate a first transmission resource used for a first sensing node to transmit a signal to a sensed node; and
receiving N pieces of reporting information from the sensed node, where the N pieces of reporting information are determined by the sensed node based on a signal transmitted by at least one sensing node through N sets of transmission resources, and the N sets of transmission resources include the first transmission resource, and the at least one sensing node includes the first sensing node, N being a positive integer.

In some embodiments, the N sets of transmission resources are independently configured.

In some embodiments, each set of transmission resources of the N sets of transmission resources includes a transmission opportunity; and the N sets of transmission resources satisfy any one of:
the N sets of transmission resources being periodic transmission resources; or
the N sets of transmission resources being transmission resources that are continuous in time domain.

In some embodiments, the N sets of transmission resources are periodic transmission resources; and the configuration information further includes at least one of:
a first time unit, where the first time unit is a time unit where a first set of transmission resources of the N sets of transmission resources is located; or
a time offset.

In some embodiments, the N sets of transmission resources are periodic transmission resources; and after transmitting the configuration information, the method further includes: transmitting first information;
where the first information includes at least one of a first time unit or a time offset, and the first time unit is a time unit where a first set of transmission resources of the N sets of transmission resources is located.

In some embodiments, the configuration information is used for the first sensing node to transmit a signal or a set of signals.

In some embodiments, the first transmission resource includes at least two transmission opportunities, and the at least two transmission opportunities satisfy any one of:
the at least two transmission opportunities being periodic transmission opportunities;
the at least two transmission opportunities being transmission opportunities that are continuous in time domain; or
the at least two transmission opportunities being transmission opportunities that are discretely distributed in time domain.

In some embodiments, the configuration information is further used to indicate a second transmission resource used for a second sensing node to transmit a signal to the sensed node, and the N sets of transmission resources include the second transmission resource.

In some embodiments, the configuration information further includes characteristic information of the first sensing node.

In some embodiments, the first sensing node corresponds to a set of transmission resources of the N sets of transmission resources.

In some embodiments, the characteristic information includes at least one of:
a device type, a device capability, power supply information, device location information, or device antenna configuration information.

FIG. 2 is a schematic diagram of an interaction flow of the information transmission method provided by the embodiments of the present disclosure. As shown in FIG. 2, the method includes the following S201 to S208.

S201, a control node transmits configuration information.

Herein, the configuration information is used to indicate N sets of transmission resources, where N is a positive integer.

It should be noted that the configuration information may be used to indicate at least one sensing node to transmit a signal through the N sets of transmission resources.

For example, at least one sensing node mentioned above may be a sensing node around a sensed node.

Exemplarily, the control node may transmit configuration information with the same configuration content to the sensed node and the sensing node.

In some embodiments of the present disclosure, the signal transmitted on the aforementioned N sets of transmission resources may be a sensing signal transmitted from the sensing node or may be a measurement signal transmitted from the sensing node.

It should be noted that, in the embodiments of the present disclosure, the configured transmission resources may include at least one of a time domain resource, a frequency domain resource, or a sequence resource.

S202, a sensed node receives the configuration information.

S203, at least one sensing node receives the configuration information.

Exemplarily, the sensed node may receive the configuration information transmitted from the control node.

S204, the at least one sensing node transmits a signal to the sensed node on the N sets of transmission resources.

S205, the sensed node receives the signal transmitted from the at least one sensing node through the N sets of transmission resources.

S206, the sensed node determines N pieces of reporting information based on the signal transmitted from the at least one sensing node.

Herein, the reporting information may be sensing result information or sensing measurement information.

S207, the sensed node transmits the N pieces of reporting information to the control node.

S208, the control node receives the N pieces of reporting information from the sensed node.

Herein, the N pieces of reporting information are determined by the sensed node based on the signal transmitted by the at least one sensing node on the N sets of transmission resources.

Exemplarily, after the control node receives the N pieces of reporting information from the sensing node, the control node may select a sensing node participating in the sensing service for the sensing node according to the N pieces of reporting information.

In the information transmission method provided by the embodiments of the present disclosure, the control node may transmit the configuration information to a sensed node and a sensed node to indicate the at least one sensing node to transmit the signal through N sets of transmission resources, and after the at least one sensing node receives the configuration information, the at least one sensing node may transmit the signal to the sensed node through the N sets of transmission resources, and after the sensed node receives the configuration information, the sensed node may receive the signal transmitted by the at least one sensing node according to the N sets of transmission resources indicated by the configuration information, and then the sensed node determines the N pieces of reporting information according to the signal received from the at least one sensing node, so that it may be determined whether the performance of the different sensing nodes for transmitting signals satisfies the requirements. The sensed node may transmit the N pieces of reporting information to the control node, so that the control node may reasonably and effectively select the sensing node participating in the sensing communication for the sensing node according to the reporting information, and thus may select the sensing nodes with higher efficiency to provide higher sensing performance for the sensed node.

In some embodiments of the present disclosure, in the information transmission method provided by the embodiments of the present disclosure, there is a one-to-one correspondence between the N pieces of reporting information and the N sets of transmission resources.

That is, the sensed node may obtain a piece of reporting information according to the signal received on a set of transmission resources of the N sets of transmission resources. That is, each configured set of transmission resources may correspond to a piece of reporting information.

Exemplarily, on one set of transmission resources, the sensing node may transmit a set of measurement signals, and the sensed node may obtain a measurement result based on the one set of measurement signals, where the measurement result corresponds to a piece of reporting information.

In the information transmission method provided by the embodiments of the present disclosure, the reporting information includes at least one of following 1-1 to 1-10.

### 1-1: Passing Result Information

Herein, the passing result information is used to indicate that a sensing result or a measurement result of a signal received on a set of transmission resources of the N sets of transmission resources satisfies a preset condition.

### 1-2: Non-Passing Result Information

Herein, the non-passing result information is used to indicate that a sensing result or a measurement result of a signal received on a set of transmission resources of the N sets of transmission resources does not satisfy a preset condition.

In a possible example, for the measurement signal on one set of transmission resources, the reporting information may not include a specific measurement result; for the sensing signal on one set of transmission resources, the reporting information may not include a specific sensing result. The reporting information may carry simple result information, for example, “0” represents the passing result information and “1” represents the non-passing result information.

Taking the signal transmitted from the sensing node as the measurement signal as an example, in a case where the result information is set to “1”, it can indicate that the measurement result of the measurement signal on the one set of transmission resources satisfies a predefined performance requirement, for example, the measurement result is greater than or equal to a threshold value of the performance requirement; in a case where the result information is set to “0”, it may indicate that the measurement result of the measurement signal on the one set of transmission resources does not satisfy the predefined performance requirement, for example, the measurement result is less than the threshold value of the performance requirement.

In a possible example, if the measurement result or sensing result passes, the information may be reported; if the measurement result or sensing result passes, the information may not be reported.

### 1-3: Permission Information

Herein, the permission information is used to indicate that a sensing node is allowed to transmit a sensing signal or a measurement signal to a sensed node, or indicate that a sensing node that transmits a signal on one set of transmission resources of the N sets of transmission resources is allowed to transmit a sensing signal or a measurement signal to a sensed node.

### 1-4: Rejection Information

Herein, the rejection information is used to indicate that a sensing node is rejected from transmitting a sensing signal or a measurement signal to a sensed node, or indicate that a sensing node that transmits a signal on one set of transmission resources of the N sets of transmission resources is rejected from transmitting a sensing signal or a measurement signal to a sensed node.

It should be noted that the sensing node that transmits the signal on the one set of transmission resources may include at least one sensing node.

In a possible example, for the measurement signal on the one set of transmission resources, the reporting information may not include a specific measurement permission result, for the sensing signal on the one set of transmission resources, the reporting information may not include a specific sensing permission result. Simple permission information or rejection information (such as “0” or “1”) may be transmitted.

Similarly, taking a signal transmitted from a sensing node as a measurement signal as an example, in a case where a permission result is set to “1”, it may indicate that a sensed node allows the sensing node that transmits the measurement signal on the one set of transmission resources to transmit the sensing signal to the sensed node; in a case where the permission result is set to “0”, it may indicate that the sensed node does not allow the sensing node that transmits the measurement signal on the one set of transmission resources to transmit the sensing signal to the sensed node.

In a possible example, if a sensed node allows a sensing node to transmit a measurement signal or a sensing signal, permission information may be reported; if a sensed node prohibits a sensing node from transmitting a measurement signal or a sensing signal, the information may not be reported.

### 1-5: Signal Amplitude Information

For example, Reference Signal Receiving Quality (RSRQ).

### 1-6: Power Information

For example, Reference Signal Receiving Power (RSRP).

### 1-7: Energy Information

For example, information such as, Signal to Noise Ratio (SNR) and Signal to Interference plus Noise Ratio (SINR).

### 1-8: Signal Phase Information

### 1-9: Signal Arrival Time Information

### 1-10: Signal Arrival Angle Information

In some embodiments of the present disclosure, in the information transmission method provided by the embodiments of the present disclosure, the configuration information may further include characteristic information of one sensing node of the at least one sensing node.

In some embodiments of the present disclosure, the aforementioned one sensing node may correspond to one set of transmission resources of N sets of transmission resources.

Herein, the sensing node corresponding to the one set of transmission resources may include one or more sensing nodes.

It can be understood that if one set of transmission resources corresponds to a sensing node, the configuration information may include characteristic information of a sensing node corresponding to the one set of transmission resources; if one set of transmission resources corresponds to at least two sensing nodes, the configuration information may include characteristic information of at least sensing node corresponding to the one set of transmission resources.

In some embodiments of the present disclosure, the configuration information may further include characteristic information of a first sensing node of the at least one sensing node. In some embodiments of the present disclosure, the first sensing node includes one or more sensing nodes.

In some embodiments of the present disclosure, the first sensing node corresponds to one set of transmission resources of the N sets of transmission resources.

Exemplarily, the configuration information may be used to indicate characteristic information of a sensing node corresponding to one set of transmission resources (for example, when there is a one-to-one correspondence between one set of transmission resources and a sensing node), and may also be used to indicate characteristic information of multiple sensing nodes corresponding to one set of transmission resources (for example, there is a one-to-many between one set of transmission resources and multiple sensing nodes).

In some embodiments of the present disclosure, the characteristic information of the sensing node may include at least one of: a device type, a device capability, power supply information, device location information, or device antenna configuration information.

For example, for a sensed node, if the sensed node does not allow to be sensed by a mobile terminal, even if a measurement signal transmitted from a mobile terminal satisfies a predefined performance requirement, since the mobile terminal is not a device type preferred by the sensed node, the sensed node can set the permission information value corresponding to the signal transmitted from the mobile terminal to “0”.

In a possible example, in a case where the sensed node detects that the device type indicated by the characteristic information of the sensed node of the configuration information is a non-preferred type, the sensed node may not receive the signal transmitted from the device on the configured transmission resources and directly determine that the value of the permission information corresponding to the one set of transmission resources is “0”.

In some embodiments of the present disclosure, in the information transmission method provided by the embodiments of the present disclosure, the above S207 may be optionally performed by the following S27a or S27b.

S27a, the sensed node transmits the N pieces of reporting information to the control node through one physical channel.

Furthermore, the S208 may be performed by the following S28a.

S28a, the control node receives the N pieces of reporting information from the sensed node through the one physical channel.

Herein, the one physical channel may be determined according to the configuration information or first information, and the first information is indication information of reported resources received after receiving the configuration information.

Exemplarily, the configuration information or the first information may also be used to indicate the physical channel resources for transmitting the reporting information, for example, the configuration information or the first information may be used to indicate at least one of a time domain resource, a frequency domain resource or a sequence resource. The sensed node may also determine a physical channel resource for transmitting the reporting information according to a transmission position of a physical transmission channel carrying the configuration information or the first information.

Exemplarily, the physical channel for transmitting the reporting information may be a Physical Uplink Control Channel (PUCCH) or a Physical Uplink Shared Channel (PUSCH).

S27b, the sensed node transmits the N pieces of reporting information to the control node through M physical channels.

Herein, M is a positive integer less than or equal to N.

Furthermore, the S208 may be performed by the following S28b.

S28b, the control node receives the N pieces of reporting information from the sensed node through M physical channels.

Exemplarily, the sensed node may transmit the reporting information in a batch reporting manner, so that a lower reporting latency may be realized, and due to the small amount of information reported at a time, a higher reliability may also be ensured.

For example, in a case where a time domain interval between each two sets of transmission resources of N sets of transmission resources is large, the sensed node may transmit reporting information separately for the signal of each sensing node, and may determine the physical channel resource for transmitting the corresponding reporting information according to a specific transmission resource of each set of transmission resources (such as a first transmission resource or a last transmission resource).

In some embodiments of the present disclosure, in the information transmission method provided by the embodiments of the present disclosure, the above S27a may be optionally performed by the following A1.

A1: the sensed node jointly encodes the N pieces of reporting information and transmits the N pieces of reporting information to the control node through one physical channel.

Exemplarily, the sensed node may concatenate the N pieces of report information according to a set number and jointly encode the N pieces of report information, or may concatenate the N pieces of report information according to a time domain resource order and jointly encode the N pieces of report information.

It can be understood that the transmission manner for transmitting the N pieces of reporting information in a joint encoding manner possesses high transmission efficiency and low power consumption.

It should be noted that the control node may configure N sets of transmission resources for transmitting the signal, each set of transmission resources may include at least one transmission opportunity, and the sensed object may obtain a report result for the signal transmitted on each set of transmission resources.

In some embodiments of the present disclosure, the information transmission method provided by the embodiments of the present disclosure may include at least one of following manner 1 to manner 3.

Manner 1: there is a one-to-one relationship between the N sets of transmission resources and the at least one sensing node.

For example, there is a one-to-one correspondence between one set of transmission resources and a sensing node. That is, the signal on one set of transmission resources of the N sets of transmission resources is transmitted from a same sensing node.

That is, among the sensing node around the sensed node, there is a transmitting manner that the sensing node transmits a signal through one set of transmission resources. Herein, the sensing node transmits a signal only on a set of transmission resources of the N sets of transmission resources, and a piece of reporting information corresponding to the one set of transmission resources is determined by the signal transmitted from the sensing node. The sensing node may be any one of the at least one sensing node.

It can be understood that if each sensing node transmits a signal on one set of transmission resources, for example, node 1 transmits a signal on the transmission resource set 1 and node 2 transmits a signal on the transmission resource set 2, then the number of the at least one sensing node may be N, i.e., the number of the sensing node may be N. The sensed node may obtain a report result for the signal transmitted from each of the N sensing nodes on the configured transmission resources. The control node may determine the sensing node included in a subsequent sensing set based on the N report results corresponding to the N sensing nodes.

Manner 2: there is a one-to-many relationship between the N sets of transmission resources and the at least one sensing node.

For example, there is a one-to-many correspondence between the one set of transmission resources and at least two sensing nodes; that is, the signal on a same set of transmission resources of the N sets of transmission resources are transmitted from at least two sensing nodes.

That is, among the sensing node around the sensed node, there is a transmitting manner that the two sensing node transmit a signal through one set of transmission resources. Herein, at least two sensing nodes transmit signals on one set of transmission resources, and a piece of reporting information corresponding to the one set of transmission resources is determined by the signal transmitted from the at least two sensing nodes.

It can be understood that the reporting information is overall reporting information obtained based on the signals transmitted from at least two sensing nodes, and is not precise to each sensing node.

For example, one set of measurement signals includes multiple measurement signals, and multiple sensing nodes transmit the measurement signal to the sensed node on each transmission resource of the one set of transmission resources, respectively.

Manner 3: there is a many-to-one relationship between the N sets of transmission resources and the at least one sensing node.

For example, there is a many-to-one relationship between multiple sets of transmission resources of the N sets of transmission resources and a same sensing node. That is, the signal on at least two sets of transmission resources of the N sets of transmission resources are transmitted from the same sensing node.

That is, among the sensing node around the sensed node, there is a transmitting manner that a sensing node transmits a signal through two sets of transmission resources. Herein, a sensing node transmits a signal on at least two sets of transmission resources, and at least two pieces of reporting information corresponding to the at least two sets of transmission resources are determined by the signal transmitted from the node.

It can be understood that the sensing node may obtain at least two pieces of reporting information based on the signal transmitted from the same sensed node, so that a result acquired according to the signal transmitted from the sensing node is more accurate.

Exemplarily, whether to configure multiple sets of transmission resources for the sensing node may be determined according to a distance between the sensing node and the sensed node.

In a possible example, if there is a sensing node that transmits a signal on at least two sets of transmission resources, the at least one sensing node may be H sensing nodes, where H is a positive integer less than N.

It should be noted that, in the embodiments of the present disclosure, among the N sets of transmission resources, one set of transmission resources may include at least one transmission opportunity (transmission resource). Herein, one transmission opportunity may correspond to one transmission of a signal, which is not specifically limited in the embodiments of the present disclosure herein.

It should be noted that in the embodiments of the present disclosure, the sensed node may not specify the number of sensed nodes and the correspondence between the sensed node and the signal. The sensed nodes can independently process the signal received on N sets of transmission resources and provide feedback.

In some embodiments of the present disclosure, the sensed node may also specify the correspondence between the sensing node and the signal, which is not specifically limited to the embodiments of the present disclosure.

In some embodiments of the present disclosure, in the information transmission method provided by the embodiments of the present disclosure, each set of transmission resources of the N sets of transmission resources is independently configured.

The control node may independently configure each set of transmission resources in the configuration information, for example, may independently configure at least one of a time domain resource, a frequency domain resource or a sequence resources of each set of transmission resources.

In some embodiments of the present disclosure, the control node may transmit a first signaling to the sensing node and the sensed node, where the first signaling includes multiple sub-signalings, a sub-signaling may be used to configure at least one set of transmission resources.

In some embodiments of the present disclosure, the control node may also transmit multiple second signalings, and each second signaling separately indicates one set of transmission resources. That is, the transmission resources between different sets are completely unrelated or have no commonality.

In some embodiments of the present disclosure, in the information transmission method provided by the embodiments of the present disclosure, each set of transmission resources of the N sets of transmission resources includes a transmission opportunity (transmission resource); and the N sets of transmission resources may satisfy any one of condition 1-1 and condition 1-2:
condition 1-1: the N sets of transmission resources being periodic transmission resources; or
condition 1-2: the N sets of transmission resources being transmission resources that are continuous in time domain.

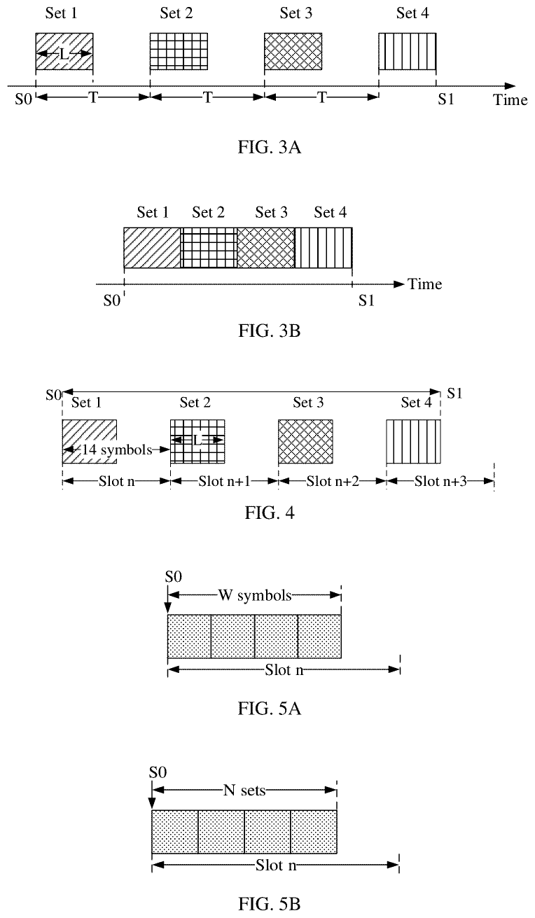

FIG. 3 are time domain schematic diagrams of a transmission resource provided by the embodiments of the present disclosure. Assume that N=4, that is, 4 sets of transmission resources are configured, and each set of transmission resources includes one transmission opportunity. As shown in FIG. 3A, a schematic diagram of the time domain periodicity of the above four sets of transmission resources is shown, which are a first set of transmission resources, a second set of transmission resources, a third set of transmission resources and a fourth set of transmission resources in chronological order. Each set of transmission resources has a same length of time L, and each set of transmission resources is separated by the same time T. Continuing with FIG. 3, as shown in FIG. 3B, a schematic diagram of time-domain continuity of the four sets of transmission resources is shown, which are a first set of transmission resources, a second set of transmission resources, a third set of transmission resources and a fourth set of transmission resources in chronological order. An end symbol of each set of transmission resources is adjacent to a start symbol of the next set of transmission resources.

It should be noted that in the embodiments of the present disclosure, a symbol length occupied by time domain resource of each transmission resource or each transmission opportunity is taken as an example for description.

In some embodiments of the present disclosure, frequency domain resources occupied by respective sets of transmission resources of the N sets of transmission resources may be the same or different. In a case where the frequency domain resources are different, the frequency domain resources of respective sets of transmission resources may be obtained by frequency hopping based on an agreed manner.

In some embodiments of the present disclosure, sequence resources occupied by respective sets of transmission resources of the N sets of transmission resources may be the same or different. In a case where the sequence resources are different, the sequence resources may be obtained by frequency hopping based on an agreed manner, for example, a parameter, a number or a cyclic shift value of the sequence used by the signal may be determined based on the agreed manner.

For the condition 1-1

In some embodiments of the present disclosure, the N sets of transmission resources may possess at least one periodicity of a time domain periodicity or a frequency domain periodicity.

For the sake of description, taking the time domain periodicity as an example, the configuration information may indicate a time domain periodicity and may also indicate at least one of: a starting symbol S0, an ending symbol S1, a time domain length L (number of symbols) of one set of transmission resources, a frequency domain resource occupied by a transmission resource, or a value of N.

FIG. 4 is a schematic diagram of a periodicity of a transmission resource provided by the embodiments of the present disclosure. As shown in FIG. 4, four sets of time-domain periodic transmission resources are configured, a starting symbol of a first set of transmission resources is S0, S0 is a starting symbol of slot n, a time interval of each set of transmission resources is 1 slot (14 symbols), and an ending symbol of a fourth set of transmission resources is S1, S1 is the Lth symbol of slot n+3 (L at this time is a positive integer less than 14).

In some embodiments of the present disclosure, in a case where the above-mentioned N sets of transmission resources are periodic transmission resources, a first time unit is determined according to second information. Herein, the first time unit is a time unit (a slot, a sub-slot, or at least one time domain symbol) where the first set of transmission resources of the above-mentioned N sets of transmission resources is located; and the first set of transmission resources is the one set of transmission resources with earliest transmission time in the N sets of transmission resources. The second information is configuration information or the above-mentioned first information.

In some embodiments of the present disclosure, the first time unit is indicated by the second information, or is determined according to a transmitting time unit of the second information and a first time offset. Herein, the first time offset is a predefined time offset or a time offset indicated by the second information.

In some embodiments of the present disclosure, in a case where the N sets of transmission resources are periodic transmission resources; the configuration information further includes at least one of: a first time unit, where the first time unit is a time unit where the first set of transmission resources of the N sets of transmission resources is located; or a time offset.

### Example 1-1

For example, the configuration information may indicate at least one of: a first time unit where the first set of measurement signals being located or a first time offset.

Furthermore, the time unit where the first set of transmission resources of N sets of transmission resources is located may be the first time unit, or may be determined by the time unit for transmitting the configuration information and the first time offset, or may be the time unit determined by the time unit for transmitting configuration information and the predefined offset.

In some embodiments of the present disclosure, after the above-mentioned S201, the following S209 may further be included.

S209: the control node transmits first information.

In a possible example, the control node may transmit the first information to the sensed node after transmitting the configuration information, so as to indicate the transmission resources for the sensed node to transmit the reporting information.

### Example 1-2

For example, the first information may indicate at least one of: a second time unit where the first set of measurement signals is located or a second time offset.

Furthermore, the time unit where the first set of transmission resources of N sets of transmission resources is located may be the second time unit, or a time unit determined by the time unit for transmitting the first information and the second time offset, or a time unit determined by the time unit determined by the time unit for transmitting first information and the predefined offset.

It should be noted that the first time unit and the second time unit may be the same time unit or different time units, and the first time offset and the second time offset may be offsets with a same value or offsets with different values, which is not specifically limited in the embodiments of the present disclosure.

For the condition 1-2

For example, concentrating the transmitting of measurement signals in a relatively short period of time can not only reduce the impact of the sensing measurement procedure on the communication procedure, but also perform the measurement with a smaller signaling overhead.

In some embodiments of the present disclosure, the configuration information may be used to indicate a starting location of N sets of transmission resources and at least one of: a duration, an end location, or value of N; where the number of time domain symbols occupied by each set of transmission resources is predefined or indicated by the configuration information.

Example 2-1: the configuration information is used to indicate the starting location and the duration of N sets of transmission resources.

Example 2-2: the configuration information is used to indicate the starting location of N sets of transmission resources and the value of N.

Example 2-3: the configuration information is used to indicate the starting location and the ending location of N sets of transmission resources.

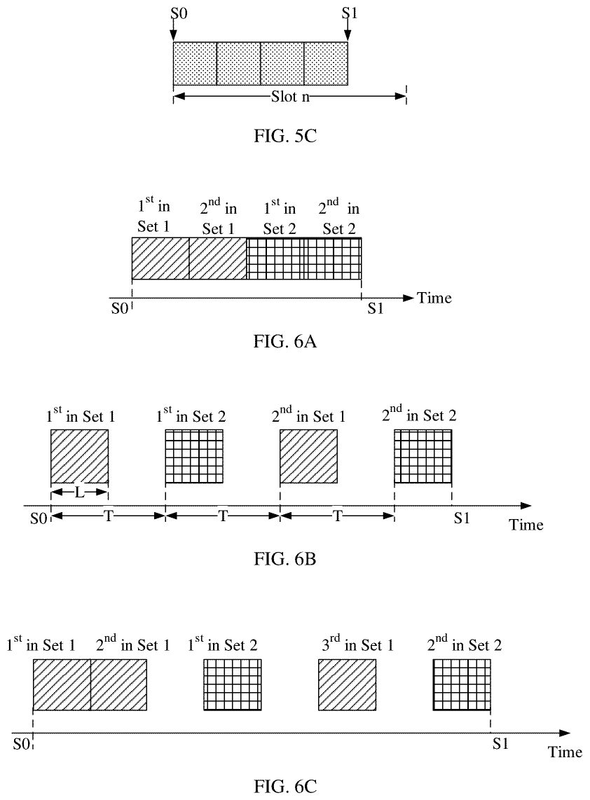

FIG. 5 are schematic diagrams of time domain continuity of transmission resources provided by the embodiments of the present disclosure. Assuming that the total length of N sets of symbols does not exceed 1 slot, as shown in FIG. 5A, the configuration information is used to indicate that the starting location S0 of the transmission resources is a first symbol of slot n, and occupying a total of W symbols. As shown in FIG. 5B, the configuration information may be used to indicate that the starting location S0 of the transmission resources is a first symbol of slot n, as well as the specific value of N. As shown in FIG. 5C, the configuration information may be used to indicate the starting location S0 and the end location S1 of the transmission resources.

In the information transmission method provided by the embodiments of the present disclosure, at least one set of transmission resources of the above-mentioned N sets of transmission resources includes at least two transmission opportunities (at least two transmission resources).

In a possible example, each set of transmission resources of the at least one set of transmission resources is independently configured.

In a possible example, for a plurality sets of transmission resources with at least two transmission opportunities, the transmission opportunities of each set of transmission resources may be independently configured.

In some embodiments of the present disclosure, a number of transmission opportunities in each set of transmission resources may be the same or different; a frequency domain resource (or a symbol resource) occupied by the transmission opportunities in each set of transmission resources may be the same or different; which are not specifically limited in the embodiments of the present disclosure.

FIG. 6 are schematic diagrams of one set of transmission resources including at least two transmission opportunities provided by the embodiments of the present disclosure. Assuming that N=2, i.e., two sets of transmission resources are configured. As shown in FIG. 6A, the two sets of transmission resources are transmission resources that are continuous in time domain, the two sets of transmission resources both include two transmission opportunities, which are, in chronological order: transmission opportunity 1 in a first set of transmission resources, transmission opportunity 2 in the first set of transmission resources, transmission opportunity 1 in a second set of transmission resources, and transmission opportunity 2 in the second set of transmission resources. As shown in FIG. 6B, the two sets of transmission resources are periodic transmission resources, respectively, the two sets of transmission resources both include two transmission opportunities, which are, in chronological order: transmission opportunity 1 in a first set of transmission resources, transmission opportunity 1 in a second set of transmission resources, transmission opportunity 2 in the first set of transmission resources, and transmission opportunity 2 in the second set of transmission resources. As shown in FIG. 6C, the first set of transmission resources includes three transmission opportunities, the second set of transmission resources includes two transmission opportunities, which are, in chronological order: transmission opportunity 1 in a first set of transmission resources, transmission opportunity 2 in the first set of transmission resources, transmission opportunity 1 in a second set of transmission resources, transmission opportunity 2 in the first set of transmission resources, and transmission opportunity 2 in second set of transmission resources.

In some embodiments of the present disclosure, the at least two transmission opportunities included in the at least one set of transmission resources may satisfy any one of condition 2-1 to condition 2-3:
condition 2-1: the at least two transmission opportunities being periodic transmission opportunities;
condition 2-2: the at least two transmission opportunities being transmission opportunities that are continuous in time domain; or
condition 2-3: the at least two transmission opportunities being transmission opportunities that are discretely distributed in time domain.

It should be noted that with respect to the condition 2-1 and condition 2-2, reference may be made to the description of the condition 1-1 and condition 1-2, which will not be repeated herein.

In some embodiments of the present disclosure, frequency domain resources occupied by respective transmission opportunities in the at least two transmission opportunities may be the same or different. In a case where the frequency domain resources are different, the frequency domain resources of respective transmission opportunities may be obtained by frequency hopping based on an agreed manner.

In some embodiments of the present disclosure, the sequence resources occupied by respective transmission opportunities in the at least two transmission opportunities may be the same or different. In a case where sequence resources are different, the sequence resources may be obtained by frequency hopping based on an agreed manner, for example, a parameter, a number, or a cyclic shift value of the sequence used by the signal may be determined based on the agreed manner.

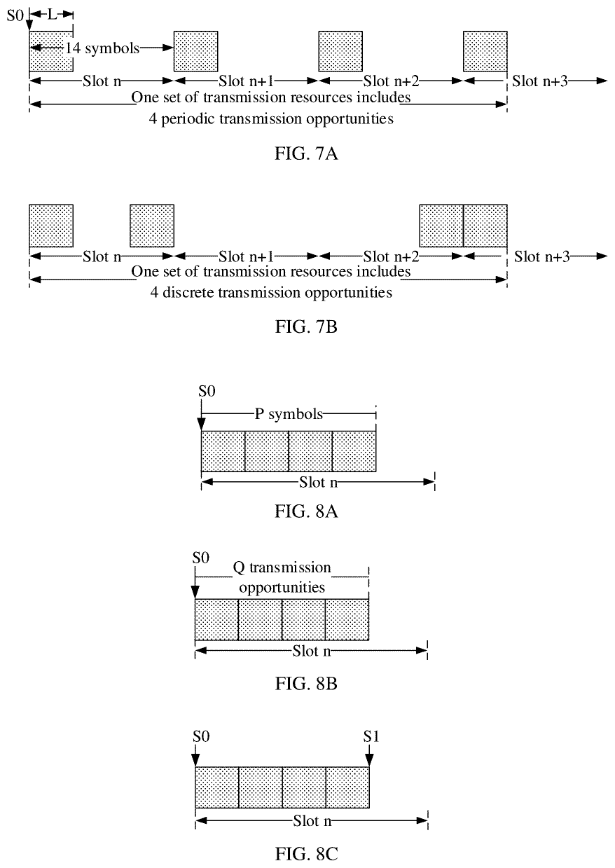

FIG. 7 are schematic diagrams of one set of transmission resources including at least two transmission opportunities provided by the embodiments of the present disclosure. Assuming that one set of transmission resources includes 4 transmission opportunities, as shown in FIG. 7A, the 4 transmission opportunities are periodic transmission opportunities, each transmission opportunity is separated by 1 slot, and the 4 transmission opportunities are the first L symbols of each slot from slot n to slot n+3. As shown in FIG. 7C, the four transmission opportunities are transmission opportunities that are discretely distributed in time domain. A first L symbol of slot n is occupied by transmission opportunity 1, a last L symbol of slot n is occupied by transmission opportunity 2, a last L symbol of slot n+2 is occupied by transmission opportunity 3, and a first L symbol of slot n+3 is occupied by transmission opportunity 4.

FIG. 8 are schematic diagrams of one set of transmission resources including at least two transmission opportunities provided by the embodiments of the present disclosure. Assuming that the at least two transmission opportunities are transmission opportunities that are continuous in time domain, a length of a time domain symbol occupied by each transmission opportunity is the same, where the length of the time domain symbol occupied by each transmission opportunity may be predefined or indicated by the configuration information. As shownin FIG. 8A, the configuration information may be used to indicate the starting location S0 and the total number of occupied symbols P of the at least two transmission opportunities; as shown in FIG. 8B, the configuration information may be used to indicate the starting location S0 and the number of transmission opportunities Q of the at least two transmission opportunities; as shown in FIG. 8C, the configuration information may be used to indicate the starting location S0 and the ending location S1 of the at least two transmission opportunities.

For the condition 2-3

In a possible implementation, the configuration information may be used to indicate a first symbol of a target slot and a second symbol spaced a preset number of symbols from the first symbol; or, the configuration information may be used to indicate a first symbol and a length of the first symbol of a target slot, a second symbol spaced a preset number of symbols from the first symbol, and a length of the second symbol.

### Example 3-1

The configuration information may be used to configure a pattern of the starting location of each transmission opportunity (e.g., a bitmap is configured).

For example: {symbol 0 in slot n, symbol 6 in slot n, symbol 12 in slot n+2, symbol 0 in slot n+3}.

Herein, a number of time domain symbols included in each transmission opportunity is predefined or indicated by the configuration information.

### Example 3-2

The configuration information may be used to configure the pattern of the starting location and duration of each transmission opportunity.

For example: {the symbol in slot n is 0 and a duration is 2 symbols, the symbol in slot n is 6 and the duration is 2 symbols, the symbol in slot n+2 is 12 and the duration is 1 symbol, the symbol in slot n+3 is 0 and the duration is 3 symbols}.

It should be noted that, in the embodiments of the present disclosure, the manner for determining the slot n may refer to the manner for determining the above-mentioned first time unit, which will not be repeated herein.

It can be understood that in a case where transmission channels from different sensing nodes to the sensed nodes are different and capabilities and power consumption of different sensing nodes are different, different numbers of transmission resource configurations may be used based on different sensing nodes.

In the embodiments of the present disclosure, for a sensing node, it is not necessary to acquire all N sets of transmission resources configured by the control node, and only needs to acquire its own transmission location. That is, the configuration information transmitted from the control node to the sensed node may be used to indicate N sets of transmission resources, indicate at least one sensed node to transmit a sensing signal or a measurement signal to the sensed node through the N sets of transmission resources, and the configuration information transmitted to each sensing node may be used to indicate transmission resources corresponding to each sensing node. The following description is made by taking the example of transmitting the configuration information from the control node to the first sensing node (any sensing node of the at least one sensing node).

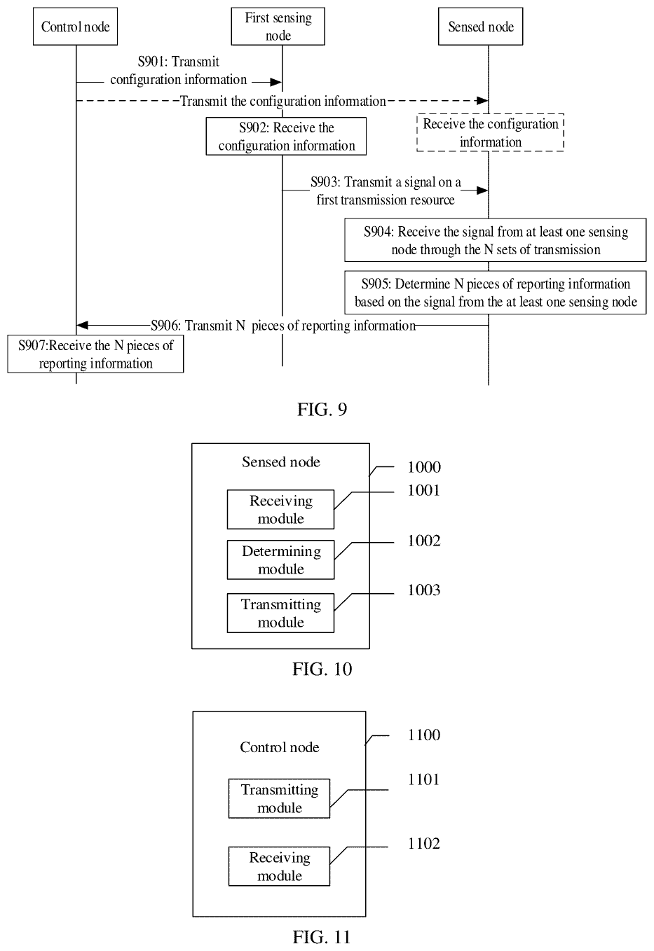

FIG. 9 is a schematic diagram of a method flow of the information transmission method provided by the embodiments of the present disclosure, which is applied to a control node to configure a transmission resource to a single sensing node, and may include the following S901 and S902.

S901, a control node transmits configuration information.

Herein, the configuration information is used to indicate a first transmission resource used for a first sensing node to transmit a signal to a sensed node, the first transmission resource is a transmission resource of N sets of transmission resources, and the N sets of transmission resources are used for at least one sensing node to transmit a signal to the sensed node, the at least one sensing node includes the first sensing node, and N is a positive integer.

It can be understood that the control node configures N sets of transmission resources for at least one sensing node, where the N sets of transmission resources include the first transmission resource.

S902, a first sensing node receives the configuration information.

It can be understood that other sensing nodes may also receive corresponding configuration information.

S903, the first sensing node ransmits a signal to a sensed node on a first transmission resource.

S904, the sensed node receives the signal from at least one sensing node through N sets of transmission resources.

S905, the sensed node determines N pieces of reporting information based on the signal from the at least one sensing node.

Herein, the N pieces of reporting information are determined by the sensed node based on the signal transmitted by at least one sensing node through N sets of transmission resources, the N sets of transmission resources include the first transmission resource, and the at least one sensing node includes a first sensing node.

The N pieces of reporting information are sensing result information or sensing measurement information.

S906, the sensed node transmits the N pieces of reporting information to the control node.

S907, the control node receives the N pieces of reporting information from the sensed node.

Herein, the N pieces of reporting information are determined by the signal transmitted on the above-mentioned N sets of transmission resources, and the above-mentioned reporting information is the sensing result information or sensing measurement information.

It can be understood that the control node may receive the N pieces of reporting information transmitted from the sensing node.

In the information transmission method provided by the embodiments of the present disclosure, when the control node transmits the configuration information, the control node may transmit the configuration information to each sensing node separately. The pieces of configuration information received by respective sensing nodes may be used to configure the transmission resources corresponding to the respective sensing nodes, so that respective sensing nodes may acquire their own transmission locations for transmitting the signals to the sensed node with less overhead.

It should be noted that, with respect to the related description of the above-mentioned N sets of transmission resources, reference may be made to the description in the above-mentioned embodiments, which will not be repeated herein.

In some embodiments of the present disclosure, in a case where the N sets of transmission resources are periodic transmission resources, after the above-mentioned S901, the following S908 may be further included.

S908, the control node transmits first information.

Herein, the first information includes at least one of a first time unit or a time offset, and the first time unit is a time unit where a first set of transmission resources of the N sets of transmission resources is located.

It should be noted that, in this solution, the manner for determining the first time unit may refer to the description in the above-mentioned embodiments, which will not be repeated herein.

In some embodiments of the present disclosure, the configuration information is used to indicate the first sensing node to transmit a signal or a set of signals.

In some embodiments of the present disclosure, in a case where the first transmission resource includes at least two transmission opportunities, the at least two transmission opportunities satisfy any one of: the at least two transmission opportunities being periodic transmission opportunities, the at least two transmission opportunities being transmission opportunities that are continuous in time domain, and the at least two transmission opportunities being transmission opportunities that are discretely distributed in time domain.

It should be noted that, with respect to the description of the first transmission resource including at least two transmission opportunities, reference may be made to the description of one transmission resource including at least two transmission opportunities in the above-mentioned embodiments, which will not be repeated herein.

In some embodiments of the present disclosure, the configuration information is further used to indicate a second transmission resource for a second sensing node to transmit a signal to a sensed node, where the above-mentioned N sets of transmission resources include the second transmission resource.

That is, the configuration information may be used to indicate transmission resources for multiple sensing nodes of the at least one sensing node to transmit a signal, respectively.

In some embodiments of the present disclosure, the control node may transmit same configuration information to each sensing node, and each sensing node acquires a corresponding transmission resource from the configuration information. The control node may also transmit corresponding configuration information to each sensing node separately or may transmit same configuration information to multiple sensing nodes of at least one sensing node.

In some embodiments of the present disclosure, the above-mentioned S902 optionally may be performed by the following S92a or S92b.

S92a, the first sensing node receives the configuration information based on a first signaling.

Herein, the first signaling includes R sub-signalings, where a first sub-signaling indicates a first transmission resource used for the first sensing node to transmit a signal to the sensed node, where R is an integer greater than 1 and less than or equal to N.

S92b, the first sensing node receives the configuration information based on a second signaling.

Herein, the second signaling indicates a first transmission resource used for the first sensing node to transmit a signal to the sensed node.

In some embodiments of the present disclosure, the configuration information further includes characteristic information of the first sensing node.

In some embodiments of the present disclosure, the first sensing node may correspond to one set of transmission resources of N sets of transmission resources.

In some embodiments of the present disclosure, the characteristic information includes at least one of: a device type, a device capability, power supply information, device location information, or device antenna configuration information.

It should be noted that other descriptions in the embodiments of the present disclosure may refer to the specific descriptions in the above-mentioned embodiments, which will not be repeated herein.

It should be noted that an executing body of the information transmission method provided by the embodiments of the present disclosure may also be an information reporting apparatus, or a control module in the information reporting apparatus for performing the information transmission method. In the embodiments of the present disclosure, a method for a sensed node and a control node to perform the information reporting is taken as an example to describe the information reporting apparatus provided by the embodiments of the present disclosure.

FIG. 10 is a structural schematic diagram of a sensed node provided by the embodiments of the present disclosure. As shown in FIG. 10, a sensed node 1000 includes: a receiving module 1001, a determining module 1002 and a transmitting module 1003. The receiving module 1001 is configured to receive configuration information, where the configuration information is used to indicate N sets of transmission resources, and N is a positive integer; the receiving module 1001 is further configured to receive a signal from at least one sensing node through the N sets of transmission resources; the determining module 1002 is configured to determine N pieces of reporting information based on the signal from the at least one sensing node; and the transmitting module 1003 is configured to transmit the N pieces of reporting information to a control node.

In some embodiments of the present disclosure, there is a one-to-one correspondence between the N pieces of reporting information and the N sets of transmission resources.

In some embodiments of the present disclosure, each of the N pieces of reporting information includes at least one of: passing result information, where the passing result information is used to indicate that a sensing result or a measurement result of a signal received on a set of transmission resources of the N sets of transmission resources satisfies a preset condition; non-passing result information, where the non-passing result information is used to indicate that a sensing result or a measurement result of a signal received on a set of transmission resources of the N sets of transmission resources does not satisfy a preset condition; permission information, where the permission information is used to indicate that a sensing node is allowed to transmit a sensing signal or a measurement signal to a sensed node, or indicate that a sensing node that transmits a signal on a set of transmission resources of the N sets of transmission resources is allowed to transmit a sensing signal or a measurement signal to a sensed node; rejection information, where the rejection information is used to indicate that a sensing node is rejected from transmitting a sensing signal or a measurement signal to a sensed node, or indicate that a sensing node that transmits a signal on a set of transmission resources of the N sets of transmission resources is rejected from transmitting a sensing signal or a measurement signal to a sensed node; signal amplitude information; power information; energy information; signal phase information; signal arrival time information; or signal arrival angle information.

In some embodiments of the present disclosure, the configuration information further includes characteristic information of one sensing node of the at least one sensing node.

In some embodiments of the present disclosure, the one sensing node corresponds to a set of transmission resources of the N sets of transmission resources.

In some embodiments of the present disclosure, the characteristic information includes at least one of: a device type, a device capability, power supply information, device location information, or device antenna configuration information.

In some embodiments of the present disclosure, the transmitting module 1003 is exemplarily configured to: transmit the N pieces of reporting information to a control node through one physical channel; or transmit the N pieces of reporting information to a control node through M physical channels, where M is a positive integer less than or equal to N.

In some embodiments of the present disclosure, the transmitting module 1003 is exemplarily configured to: jointly encode the N pieces of reporting information and transmit the N pieces of reporting information to the control node through the one physical channel.

In some embodiments of the present disclosure, there is a one-to-one relationship between the N sets of transmission resources and the at least one sensing node; or, there is a one-to-many relationship between the N sets of transmission resources and the at least one sensing node; or, there is a many-to-one relationship between the N sets of transmission resources and the at least one sensing node.

In some embodiments of the present disclosure, each set of transmission resources of the N sets of transmission resources is independently configured.

In some embodiments of the present disclosure, each set of transmission resources of the N sets of transmission resources includes a transmission opportunity; the N sets of transmission resources satisfy any one of: the N sets of transmission resources being periodic transmission resources; the N sets of transmission resources being transmission resources that are continuous in time domain.

In some embodiments of the present disclosure, at least one set of transmission resources of the N sets of transmission resources includes at least two transmission opportunities; where the at least two transmission opportunities satisfy any one of: the at least two transmission opportunities being periodic transmission opportunities; the at least two transmission opportunities being transmission opportunities that are continuous in time domain; the at least two transmission opportunities being transmission opportunities that are discretely distributed in time domain.

The embodiments of the present disclosure provide a sensed node. After the sensed node receives the configuration information, the sensed node may receive a signal transmitted by at least one sensing node according to N sets of transmission resources indicated by the configuration information, and then acquire N pieces of reporting information according to the signal received from the at least one sensing node, so as to be capable of determining whether the performance of transmitting signals by different sensing nodes satisfies requirements. The sensed node may transmit the N pieces of reporting information to the control node, so that the control node may reasonably and effectively select the sensing node participating in the sensing communication for the sensing node according to the reporting information, and thus may select the sensing nodes with higher efficiency to provide higher sensing performance for the sensed node.

The sensed node 1000 provided by the embodiments of the present disclosure may implement each procedure implemented in the method embodiments of FIG. 1 to FIG. 9, which will not be repeated herein to avoid repetition.

FIG. 11 is a structural schematic diagram of a control node provided by the embodiments of the present disclosure. As shown in FIG. 11, the control node 1100 includes: a transmitting module 1101 and a receiving module 1102. The transmitting module 1101 is configured to transmit configuration information, where the configuration information is used to indicate N sets of transmission resources, and the N sets of transmission resources are used for at least one sensing node to transmit a signal to a sensed node, and N is a positive integer; and the receiving module 1102 is configured to receive N pieces of reporting information from the sensed node, where the N pieces of reporting information is determined by the sensed node based on the signal transmitted by the at least one sensing node on the N sets of transmission resources.

In some embodiments of the present disclosure, there is a one-to-one correspondence between the N pieces of reporting information and the N sets of transmission resources.

In some embodiments of the present disclosure, each set of transmission resources of the N sets of transmission resources is independently configured.

In some embodiments of the present disclosure, each set of transmission resources of the N sets of transmission resources includes a transmission opportunity; the N sets of transmission resources satisfy any one of: the N sets of transmission resources being periodic transmission resources; the N sets of transmission resources being transmission resources that are continuous in time domain.

In some embodiments of the present disclosure, the N sets of transmission resources are periodic transmission resources; the configuration information further includes at least one of: a first time unit, where the first time unit is a time unit where the first set of transmission resources of the N sets of transmission resources is located; or a time offset.

In some embodiments of the present disclosure, the N sets of transmission resources are periodic transmission resources; after transmitting the configuration information, the method further includes: transmitting first information; where the first information includes at least one of a first time unit or a time offset, and the first time unit is a time unit where a first set of transmission resources of the N sets of transmission resources is located.

In some embodiments of the present disclosure, at least one set of transmission resources of the N sets of transmission resources includes at least two transmission opportunities; where the at least two transmission opportunities satisfy any one of: the at least two transmission opportunities being periodic transmission opportunities; the at least two transmission opportunities being transmission opportunities that are continuous in time domain; the at least two transmission opportunities being transmission opportunities that are discretely distributed in time domain.

In some embodiments of the present disclosure, there is a one-to-one relationship between the N sets of transmission resources and the at least one sensing node; or, there is a one-to-many relationship between the N sets of transmission resources and the at least one sensing node; or, there is a many-to-one relationship between the N sets of transmission resources and the at least one sensing node.

In some embodiments of the present disclosure, the configuration information further includes characteristic information of a first sensing node of the at least one sensing node.

In some embodiments of the present disclosure, the first sensing node corresponds to a set of transmission resources of the N sets of transmission resources.

In some embodiments of the present disclosure, the characteristic information includes at least one of: a device type, a device capability, power supply information, device location information or device antenna configuration information.

In some embodiments of the present disclosure, the reporting information includes at least one of: passing result information, where the passing result information is used to indicate that a sensing result or a measurement result of a signal received on a set of transmission resources of the N sets of transmission resources satisfies a preset condition; non-passing result information, where the non-passing result information is used to indicate that a sensing result or a measurement result of a signal received on a set of transmission resources of the N sets of transmission resources does not satisfy a preset condition; permission information, where the permission information is used to indicate that a sensing node is allowed to transmit a sensing signal or a measurement signal to a sensed node, or indicate that a sensing node that transmits a signal on a set of transmission resources of the N sets of transmission resources is allowed to transmit a sensing signal or a measurement signal to a sensed node; rejection information, where the rejection information is used to indicate that a sensing node is rejected from transmitting a sensing signal or a measurement signal to a sensed node, or indicate that a sensing node that transmits a signal on a set of transmission resources of the N sets of transmission resources is rejected from transmitting a sensing signal or a measurement signal to a sensed node; signal amplitude information; power information; energy information; signal phase information; signal arrival time information; or signal arrival angle information.

In some embodiments of the present disclosure, the receiving module 1102 is exemplarily configured to: receive the N pieces of reporting information from the sensed node through one physical channel; or, receive the N pieces of reporting information from the sensed node through M physical channels, where M is a positive integer less than or equal to N.

The embodiments of the present disclosure provide a control node, the control node may transmit configuration information to a sensing node and a sensed node to indicate at least one sensing node to transmit a signal through N sets of transmission resources. After the sensed node receives the configuration information, the sensed node may receive the signal transmitted by the at least one sensing node according to the N sets of transmission resources indicated by the configuration information, and then obtain N pieces of reporting information according to the signal received from the at least one sensing node, so as to be capable of determining whether the performance of transmitting signals by different sensing nodes satisfies the requirements. The sensed node may transmit the N pieces of reporting information to the control node, so that the control node may reasonably and effectively select the sensing node participating in the sensing communication for the sensing node according to the reporting information, and thus may select the sensing nodes with higher efficiency to provide higher sensing performance for the sensed node.

The control node 1100 provided by the embodiments of the present disclosure may implement each procedure implemented in the method embodiments of FIG. 1 to FIG. 9, which will not be repeated herein to avoid repetition.

In some embodiments of the present disclosure, a structural diagram of a control node is provided by the embodiments of the present disclosure, continuing in conjunction with FIG. 11, the control node 1100 includes: a transmitting module 1101 and a receiving module 1102. The transmitting module 1101 is configured to transmit configuration information, where the configuration information is used to indicate a first transmission resource used for a first sensing node to transmit a signal to a sensed node; and the receiving module 1102 is configured to receive N pieces of reporting information from the sensed node, where the N pieces of reporting information is determined by the sensed node based on a signal transmitted by at least one sensing node through N sets of transmission resources, the N sets of transmission resources include a first transmission resource, the at least one sensing node includes the first sensing node, and N is a positive integer.

In some embodiments of the present disclosure, the N sets of transmission resources are independently configured.

In some embodiments of the present disclosure, each set of transmission resources of the N sets of transmission resources includes a transmission opportunity; the N sets of transmission resources satisfy any one of: the N sets of transmission resources being periodic transmission resources; the N sets of transmission resources being transmission resources that are continuous in time domain.

In some embodiments of the present disclosure, the N sets of transmission resources are periodic transmission resources; the configuration information further includes at least one of: a first time unit, where the first time unit is a time unit where the first set of transmission resources of the N sets of transmission resources is located; or a time offset.

In some embodiments of the present disclosure, the N sets of transmission resources are periodic transmission resources; the transmitting module 1101 is further configured to transmit first information after transmitting the configuration information; where the first information includes at least one of a first time unit or a time offset, and the first time unit is a time unit where the first set of transmission resources of the N sets of transmission resources is located.

In some embodiments of the present disclosure, the configuration information is used by the first sensing node to transmit a signal or a set of signals.

In some embodiments of the present disclosure, the first transmission resource includes at least two transmission opportunities; where the at least two transmission opportunities satisfy any one of: the at least two transmission opportunities being periodic transmission opportunities; the at least two transmission opportunities being transmission opportunities that are continuous in time domain; or the at least two transmission opportunities being transmission opportunities that are discretely distributed in time domain.

In some embodiments of the present disclosure, the configuration information is further used to indicate a second transmission resource for a second sensing node to transmit a signal to a sensed node, and the N sets of transmission resources include the second transmission resource.

In some embodiments of the present disclosure, the configuration information further includes characteristic information of the first sensing node.

In some embodiments of the present disclosure, the first sensing node corresponds to a set of transmission resources of the N sets of transmission resources.

In some embodiments of the present disclosure, the characteristic information includes at least one of: a device type, a device capability, power supply information, device location information, or device antenna configuration information.

The embodiments of the present disclosure provide a control node, the control node may transmit configuration information to a sensing node to indicate a transmission resource for the sensing node to transmit the signal, and after the sensing node receives the configuration information, the sensing node may transmit the signal to the sensed node according to the transmission resource indicated by the configuration information, and the sensed node obtains N pieces of reporting information according to the received signal, so as to be capable of determining whether the performance of transmitting signals by different sensing nodes satisfies the requirements. The sensed node may transmit the N pieces of reporting information to the control node, so that the control node may reasonably and effectively select the sensing node participating in the sensing communication for the sensing node according to the reporting information, and thus may select the sensing nodes with higher efficiency to provide higher sensing performance for the sensed node.

The control node 1100 provided by the embodiments of the present disclosure may implement each procedure implemented in the method embodiments of FIG. 1 to FIG. 9, which will not be repeated herein to avoid repetition.

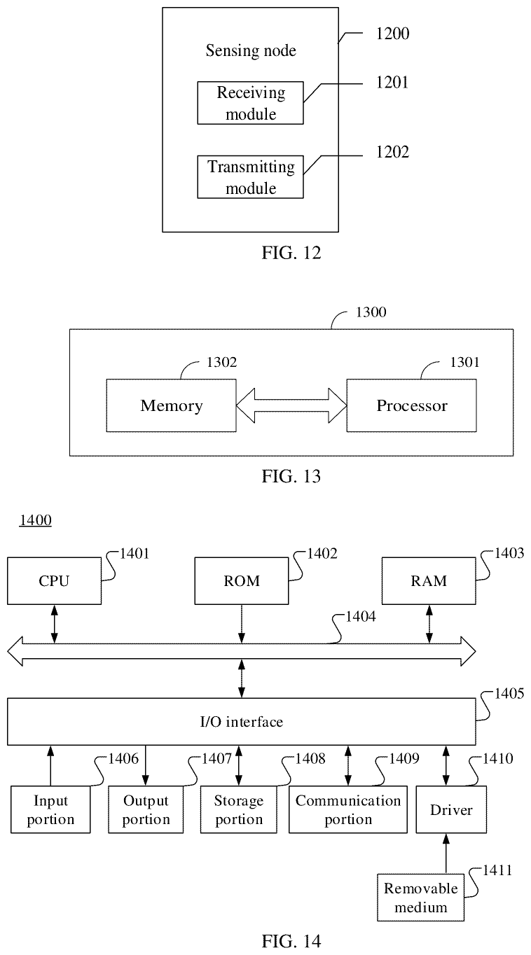

FIG. 12 is a structural schematic diagram of a sensing node provided by the embodiments of the present disclosure, and the sensing node is a first sensing node. As shown in FIG. 12, the sensing node 1200 includes: a receiving module 1201 and a transmitting module 1202. The receiving module 1201 is configured to receive configuration information, where the configuration information is used to indicate a first transmission resource used for the first sensing node to transmit a signal to a sensed node, and the first transmission resource is a transmission resource of N sets of transmission resources, and the N sets of transmission resources are used for at least one sensing node to transmit a signal to the sensed node, and the at least one sensing node includes the first sensing node, and N is a positive integer; and the transmitting module 1202 is configured to transmit a signal to the sensed node on the first transmission resource.

In some embodiments of the present disclosure, the configuration information is used to indicate a transmission resource for the first sensing node to transmit a signal or a set of signals.

In some embodiments of the present disclosure, the configuration information further includes characteristic information of the first sensing node.

In some embodiments of the present disclosure, the first sensing node corresponds to a set of transmission resources of the N sets of transmission resources.

In some embodiments of the present disclosure, the characteristic information includes at least one of: a device type, a device capability, power supply information, device location information, or device antenna configuration information.

In some embodiments of the present disclosure, each set of transmission resources of the N sets of transmission resources is independently configured.

In some embodiments of the present disclosure, each set of transmission resources of the N sets of transmission resources includes a transmission opportunity; the N sets of transmission resources satisfy any one of: the N sets of transmission resources being periodic transmission resources; the N sets of transmission resources being transmission resources that are continuous in time domain.

In some embodiments of the present disclosure, the N sets of transmission resources are periodic transmission resources; the configuration information further includes at least one of: a first time unit, where the first time unit is a time unit where the first set of transmission resources of the N sets of transmission resources is located; or a time offset.

In some embodiments of the present disclosure, the first transmission resource includes at least two transmission opportunities; where the at least two transmission opportunities satisfy any one of: the at least two transmission opportunities being periodic transmission opportunities; the at least two transmission opportunities being transmission opportunities that are continuous in time domain; the at least two transmission opportunities being transmission opportunities that are discretely distributed in time domain.

In some embodiments of the present disclosure, the receiving module 1201 is exemplarily configured to receive the configuration information based on a first signaling, the first signaling includes R sub-signalings, the first sub-signaling is used to indicate a first transmission resource used for a first sensing node to transmit a signal to a sensed node, R is an integer greater than 1 and less than or equal to N; or, receive the configuration information based on a second signaling, where the second signaling is used to indicate a first transmission resource used for the first sensing node to transmit a signal to the sensed node.

The embodiments of the present disclosure provide a sensing node, the control node may transmit configuration information to a sensing node to indicate a transmission resource for the sensing node to transmit the signal, and after the sensing node receives the configuration information, the sensing node may transmit the signal to the sensed node according to the first transmission resource indicated by the configuration information, and the sensed node obtains N pieces of reporting information according to the received signal, so as to be capable of determining whether the performance of transmitting signals by different sensing nodes satisfies the requirements. The sensed node may transmit the N pieces of reporting information to the control node, so that the control node may reasonably and effectively select the sensing node participating in sensing communication for the sensing node according to the reporting information, and thus may select the sensing node with higher efficiency to provide higher sensing performance for the sensed node.

The sensing node 1200 provided by the embodiments of the present disclosure may implement each procedure implemented in the method embodiments of FIG. 1 to FIG. 9, which will not be repeated herein to avoid repetition.

In some embodiments of the present disclosure, as shown in FIG. 13, the embodiments of the present disclosure further provide a node 1300, including a processor 1301, a memory 1302, and a program or instructions stored in the memory 1302 and runnable on the processor 1301. When the program or the instructions is executed by the processor 1301, each procedure of the above-mentioned information transmission method embodiments is implemented, and the same technical effects may be achieved, which will not be repeated herein to avoid repetition.

In some embodiments of the present disclosure, the node 1300 may be the above-mentioned control node, sensing node, or sensed node.

It should be noted that a node 1400 shown in FIG. 14 is only an example and should not impose any limitation to the functions and scope of usage of the embodiments of the present disclosure.

As shown in FIG. 14, the node 1400 includes a central processing unit (CPU) 1401, which may perform various appropriate operations and processes according to a program stored in a read only memory (ROM) 1402 or a program loaded into a random access memory (RAM) 1403 from a storage portion 1408. In the RAM 1403, various programs and data necessary for the operation of the system are also stored. The CPU 1401, the ROM 1402, and the RAM 1403 are connected to one another via a bus 1404. An input/output (I/O) interface 1405 is also connected to the bus 1404.

The following components are connected to the I/O interface 1405: an input portion 1406 including a keyboard, a mouse, etc.; an output portion 1407 including such as a Cathode Ray Tube (CRT), a liquid crystal display (LCD), etc. and a speaker, etc.; a storage portion 1408 including a hard disk, etc.; and a communication portion 1409 including a network interface card such as a Local Area Network (LAN) card, a modem, etc. The communication portion 1409 performs communication processing via a network such as the Internet. A drive 1410 is also connected to the I/O interface 1405 as needed. A removable medium 1411, such as a magnetic disk, an optical disk, a magneto-optical disk, a semiconductor memory, or the like, is mounted on the drive 1410 as needed, so that a computer program read therefrom is installed into the storage portion 1408 as needed.

In particular, according to the embodiments of the present disclosure, the procedure described below with reference to the flow chart may be implemented as a computer software program. For example, the embodiments of the present disclosure include a computer program product, the computer program product includes a computer program carried on a computer-readable medium, and the computer program contains program codes for performing the method shown in the flow chart. In such an embodiment, the computer program may be downloaded and installed from a network via the communication portion 1409, and/or installed from the removable medium 1411. When the computer program is performed by the central processing unit (CPU 1401), various functions defined in the system of the present disclosure are performed.

Embodiments of the present disclosure further provide a readable storage medium, the readable storage medium stores thereon a program or instructions. The processor is configured to implement various procedures of the above-mentioned information transmission method embodiments when the program or the instructions is executed, and the same technical effects may be achieved, which will not be repeated herein to avoid repetition.

Herein, the processor is a processor in the electronic device described in the above embodiments. The readable storage medium includes computer-readable storage medium, such as ROM, RAM, a magnetic disk or an optical disk, etc.

The embodiments of the present disclosure further provide a chip, the chip includes a processor and a communication interface, where the communication interface is coupled to the processor, and the processor is configured to implement the various procedures of the above-mentioned information transmission method embodiments when performing a program or instruction, and may achieve same technical effects, which will not be repeated herein to avoid repetition.

It should be understood that the chip mentioned in the embodiments of the present disclosure may also be referred to as a system on chip, a system chip, a chip system, or a system-on-chip chip, etc.

The embodiments of the present disclosure provide a computer program product including instructions when the instructions are executed on a computer, enabling a computer to execute steps of the information transmission method described above and achieve the same technical effects, which will not be repeated herein to avoid repetition.

It should be noted that, as used herein, the terms “including”, “containing” or any other variation thereof are intended to encompass non exclusive inclusion, such that a procedure, method, article, or apparatus that includes a series of elements not only includes those elements, but also includes other elements not explicitly listed, or also includes elements inherent to such procedure, method, article, or apparatus. Without further limitations, the element limited by the statement ‘including one . . . ’ does not exclude the existence of other identical elements in the procedure, method, article, or apparatus that includes that element. In addition, it should be pointed out that the scope of the methods and apparatuses in the embodiments of the present disclosure is not limited to performing functions in the order shown or discussed, but may also include performing functions in a substantially simultaneous manner or in a reverse order according to the functions involved. For example, the described methods may be performed in an order different from that described, and various steps may be added, omitted, or combined. Additionally, features described with reference to certain examples may be combined in other examples.

Through the description of the above implementations, those skilled in the art may clearly understand that the above-mentioned embodiment methods can be implemented by means of software plus a necessary general hardware platform, and of course by hardware, but in many cases the former is a better implementation. Based on this understanding, the technical solution of the present disclosure essentially, or a part of the technical solution that contributes to the prior art may be embodied in the form of a software product, and the computer product is stored in a storage medium (such as ROM/RAM, a magnetic disk, an optical disk) and includes multiple instructions for enabling a terminal (which may be a mobile phone, a computer, a server, an air conditioner, or a network device, etc.) to perform the methods described in various embodiments of the present disclosure.

The embodiments of the present disclosure have been described above in conjunction with the accompanying drawings, but the present disclosure is not limited to the specific embodiments described above. The specific embodiments described above are only illustrative and not restrictive. Those of ordinary skill in the art can also make many forms within the scope of protection of the present disclosure without departing from the purpose and claims of the present disclosure.

What is claimed is:

1. An information transmission method, applied to a sensed node and comprising:
receiving configuration information, wherein the configuration information is used to indicate N sets of transmission resources, N being a positive integer;
receiving a signal from at least one sensing node through the N sets of transmission resources;
determining N pieces of reporting information based on the signal from the at least one sensing node; and
transmitting the N pieces of reporting information to a control node.

2. The method according to claim 1, wherein there is a one-to-one correspondence between the N pieces of reporting information and the N sets of transmission resources.

3. The method according to claim 1, wherein each piece of reporting information of the N pieces of reporting information comprises at least one of:
passing result information, wherein the passing result information is used to indicate that a sensing result or a measurement result of a signal received on a set of transmission resources of the N sets of transmission resources satisfies a preset condition;
non-passing result information, wherein the non-passing result information is used to indicate that a sensing result or a measurement result of a signal received on a set of transmission resources of the N sets of transmission resources does not satisfy a preset condition;
permission information, wherein the permission information is used to indicate that a sensing node is allowed to transmit a sensing signal or a measurement signal to the sensed node, or indicate that a sensing node that transmits a signal on a set of transmission resources of the N sets of transmission resources is allowed to transmit a sensing signal or a measurement signal to the sensed node;
rejection information, wherein the rejection information is used to indicate that a sensing node is rejected from transmitting a sensing signal or a measurement signal to the sensed node, or indicate that a sensing node that transmits a signal on a set of transmission resources of the N sets of transmission resources is rejected from transmitting a sensing signal or a measurement signal to the sensed node;
signal amplitude information;
power information;
energy information;
signal phase information;
signal arrival time information; or
signal arrival angle information.

4. The method according to claim 1, wherein the configuration information further comprises characteristic information of one sensing node of the at least one sensing node; and
wherein the one sensing node corresponds to a set of transmission resources of the N sets of transmission resources; and
the characteristic information comprises at least one of:
a device type, a device capability, power supply information, device location information, or device antenna configuration information.

5. The method according to claim 1, wherein transmitting the N pieces of reporting information to the control node comprises:
transmitting the N pieces of reporting information to the control node through one physical channel; or
transmitting the N pieces of reporting information to the control node through M physical channels, wherein M is a positive integer less than or equal to N.

6. The method according to claim 5, wherein transmitting the N pieces of reporting information to the control node through the one physical channel comprises:
jointly encoding the N pieces of reporting information and transmitting the N pieces of reporting information to the control node through the one physical channel.

7. The method according to claim 1, wherein
there is a one-to-one relationship between the N sets of transmission resources and the at least one sensing node; or
there is a one-to-many relationship between the N sets of transmission resources and the at least one sensing node; or
there is a many-to-one relationship between the N sets of transmission resources and the at least one sensing node.

8. The method according to claim 1, wherein each set of transmission resources of the N sets of transmission resources is independently configured.

9. The method according to claim 1, wherein each set of transmission resources of the N sets of transmission resources comprises a transmission opportunity; and the N sets of transmission resources satisfy any one of:
the N sets of transmission resources being periodic transmission resources; or
the N sets of transmission resources being transmission resources that are continuous in time domain.

10. The method according to claim 1, wherein at least one set of transmission resources of the N sets of transmission resources comprises at least two transmission opportunities; and
the at least two transmission opportunities satisfy any one of:
the at least two transmission opportunities being periodic transmission opportunities;
the at least two transmission opportunities being transmission opportunities that are continuous in time domain; or
the at least two transmission opportunities being transmission opportunities that are discretely distributed in time domain.

11. A sensed node, comprising: a processor, a memory, and a program or instructions stored in the memory and runnable on the processor, wherein the processor, when executing the program or the instructions, is configured to perform:
receiving configuration information, wherein the configuration information is used to indicate N sets of transmission resources, N being a positive integer;
receiving a signal from at least one sensing node through the N sets of transmission resources;
determining N pieces of reporting information based on the signal from the at least one sensing node; and
transmitting the N pieces of reporting information to a control node.

12. A control node, comprising a processor, a memory, and a program or instructions stored in the memory and runnable on the processor, wherein the processor, when executing the program or the instructions, is configured to perform:
transmitting configuration information, wherein the configuration information is used to indicate N sets of transmission resources, and the N sets of transmission resources are used for at least one sensing node to transmit a signal to a sensed node, N being a positive integer; and
receiving N pieces of reporting information from the sensed node, wherein the N pieces of reporting information are determined by the sensed node based on a signal transmitted by the at least one sensing node on the N sets of transmission resources.

13. The control node according to claim 12, wherein there is a one-to-one correspondence between the N pieces of reporting information and the N sets of transmission resources; and
each set of transmission resources of the N sets of transmission resources is independently configured.

14. The control node according to claim 12, wherein each set of transmission resources of the N sets of transmission resources comprises a transmission opportunity; and the N sets of transmission resources satisfy any one of:
the N sets of transmission resources being periodic transmission resources; or
the N sets of transmission resources being transmission resources that are continuous in time domain;
wherein the N sets of transmission resources are periodic transmission resources, and the configuration information further comprises at least one of:
a first time unit, where the first time unit is a time unit where a first set of transmission resources of the N sets of transmission resources is located; or
a time offset.

15. The control node according to claim 14, wherein the N sets of transmission resources are periodic transmission resources; and the processor, when executing the program or the instructions, is configured to further perform:
transmitting first information;
wherein the first information comprises at least one of the first time unit or the time offset, and the first time unit is a time unit where a first set of transmission resources of the N sets of transmission resources is located.

16. The control node according to claim 12, wherein at least one set of transmission resources of the N sets of transmission resources comprises at least two transmission opportunities; and the at least two transmission opportunities satisfy any one of:
the at least two transmission opportunities being periodic transmission opportunities;
the at least two transmission opportunities being transmission opportunities that are continuous in time domain; or
the at least two transmission opportunities being transmission opportunities that are discretely distributed in time domain.

17. The control node according to claim 12, wherein
there is a one-to-one relationship between the N sets of transmission resources and the at least one sensing node; or
there is a one-to-many relationship between the N sets of transmission resources and the at least one sensing node; or
there is a many-to-one relationship between the N sets of transmission resources and the at least one sensing node.

18. The control node according to claim 12, wherein
the configuration information further comprises characteristic information of a first sensing node of the at least one sensing node; and
wherein the first sensing node corresponds to a set of transmission resources of the N sets of transmission resources; and
the characteristic information comprises at least one of:
a device type, a device capability, power supply information, device location information, or device antenna configuration information.

19. The control node according to claim 12, wherein the reporting information comprises at least one of:
passing result information, wherein the passing result information is used to indicate that a sensing result or a measurement result of a signal received on a set of transmission resources of the N sets of transmission resources satisfies a preset condition;
non-passing result information, wherein the non-passing result information is used to indicate that a sensing result or a measurement result of a signal received on a set of transmission resources of the N sets of transmission resources does not satisfy a preset condition;
permission information, wherein the permission information is used to indicate that a sensing node is allowed to transmit a sensing signal or a measurement signal to the sensed node, or indicate that a sensing node that transmits a signal on a set of transmission resources of the N sets of transmission resources is allowed to transmit a sensing signal or a measurement signal to the sensed node;
rejection information, wherein the rejection information is used to indicate that a sensing node is rejected from transmitting a sensing signal or a measurement signal to the sensed node, or indicate that a sensing node that transmits a signal on a set of transmission resources of the N sets of transmission resources is rejected from transmitting a sensing signal or a measurement signal to the sensed node;
signal amplitude information;
power information;
energy information;
signal phase information;
signal time of arrival information; or
signal angle of arrival information.

20. The control node according to claim 12, wherein receiving the N pieces of reporting information from the sensed node comprises:
receiving the N pieces of reporting information from the sensed node through one physical channel; or
receiving the N pieces of reporting information from the sensed node through M physical channels, wherein M is a positive integer less than or equal to N.
